(19) United States
(12) Patent Application Publication
(10) Pub. No.: US 2014/0150726 A1
(43) Pub. Date: Jun. 5, 2014

(54) BIRDFEEDER

(71) Applicant: Thomas Keith Moone, Chargin Falls, OH (US)

(72) Inventor: Thomas Keith Moone, Chargin Falls, OH (US)

(73) Assignee: Nature's Way LLC, Chargin Falls, OH (US)

(21) Appl. No.: 13/892,049

(22) Filed: May 10, 2013

Related U.S. Application Data
(60) Provisional application No. 61/645,567, filed on May 10, 2012.

(51) Int. Cl. A01K 39/01

(52) U.S. Cl. CPC A01K 39/01
USPC 119/57.8; 119/51.01

(57) ABSTRACT

A birdfeeder (10) is provided wherein a housing (20) defines a compartment (21) which is much wider than it is tall or deep. The housing (20) can comprise a plastic tube (30), lateral end lids (40), and a door (50). Perches (60) extend beyond the compartment (21), and a roof (80) is removably attachable to the housing (20).

### RELATED APPLICATION

This application claims priority under 35 USC §119(e) to U.S. Provisional Patent Application No. 61/645567 filed on May 10, 2012.

The entire disclosure of this provisional patent application is hereby incorporated by reference.

### BACKGROUND

A birdfeeder is often placed in a backyard or other outside venues to attract birds to the area. A birdfeeder will typically include a housing defining a birdfeed-containing compartment. In one popular birdfeeder style, the housing includes a clear plastic tube having a height dimension that greatly exceeds its width and depth dimensions.

### SUMMARY

A birdfeeder is provided wherein the housing defines a birdfeed-containing compartment and includes a plastic tube. In contrast to conventional tube-birdfeeder designs, the height dimension of the plastic tube greatly exceeds its width and depth dimensions.

### DRAWINGS

FIG. 1 shows the birdfeeder 10.

FIGS. 2-9 show a housing 20, a housing tube 30, housing end lids 40, a housing door 50, a perch 60, a baffle 70, a roof 80, and a feed-port insert 90.

FIG. 10 shows a stacked assembly 100 of the birdfeeders 10.

FIG. 11 shows a birdfeeder 10 without feed-port inserts 90.

### DESCRIPTION

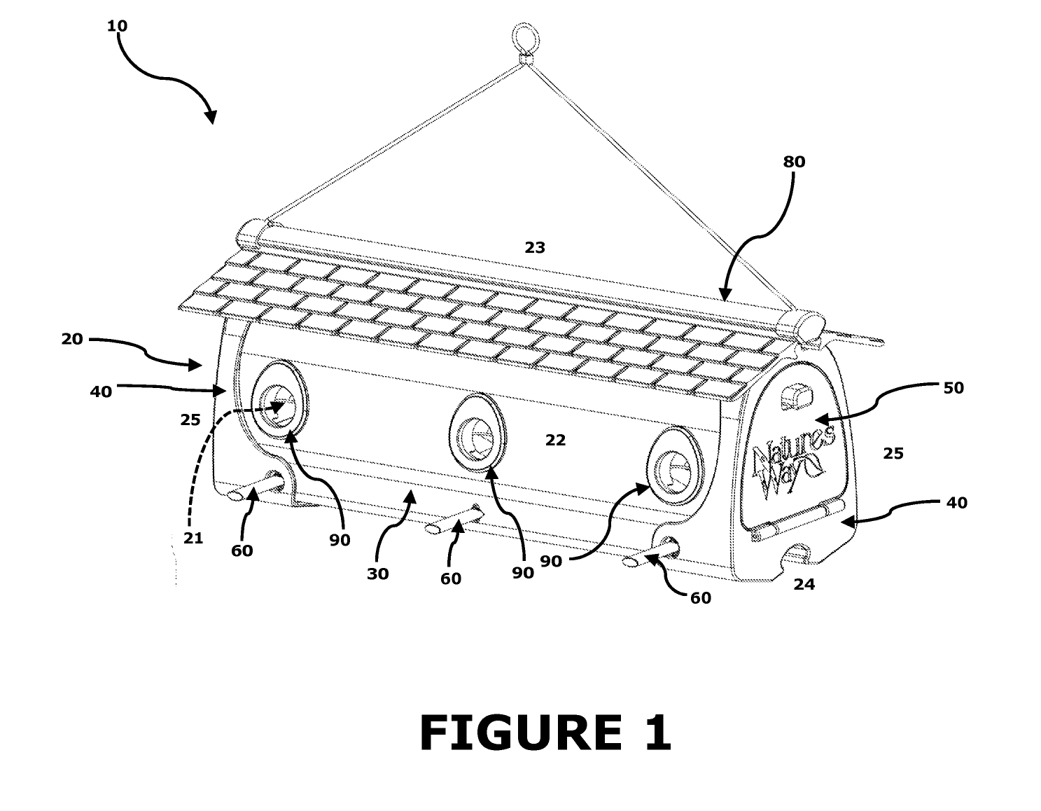

Referring to FIG. 1, the birdfeeder 10 comprises a housing 20 defining a birdfeed-containing compartment 21 having a front and rear sides 22, a top side 23, a bottom side 24, and lateral sides 25. The birdfeeder 10 is preferably sized so that its lateral length dimension (i.e., the distance between its lateral sides 25) greatly exceeds its depth dimension (i.e., the distance between its front and rear sides 22) and its height dimension (i.e., the distance between its top side 23 and its bottom side 24).

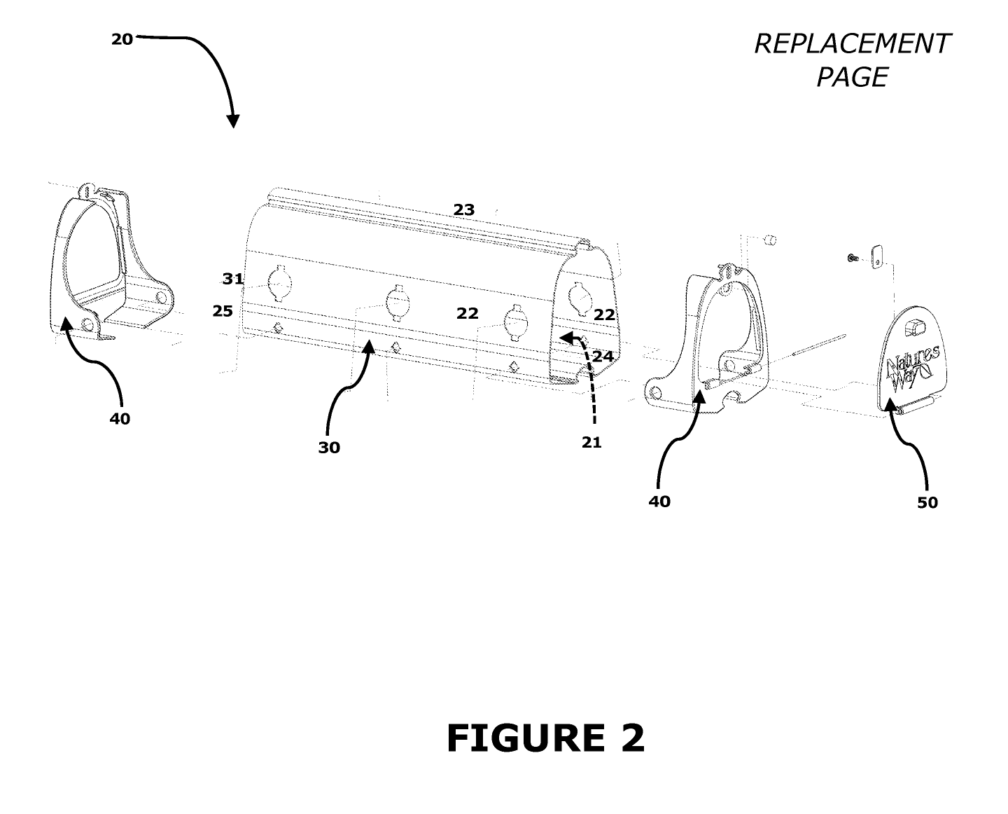

Referring to FIG. 2, the housing 20 comprises a tube 30, lateral lids 40, and a door 50. The tube 30 defines sides 22-25 of the bird feed. The lids 40 are removably attached to the housing tube 30 and cover its open lateral ends 31. The door 50 allows access to the birdfeed-containing compartment 21 through one of the lateral lids 40.

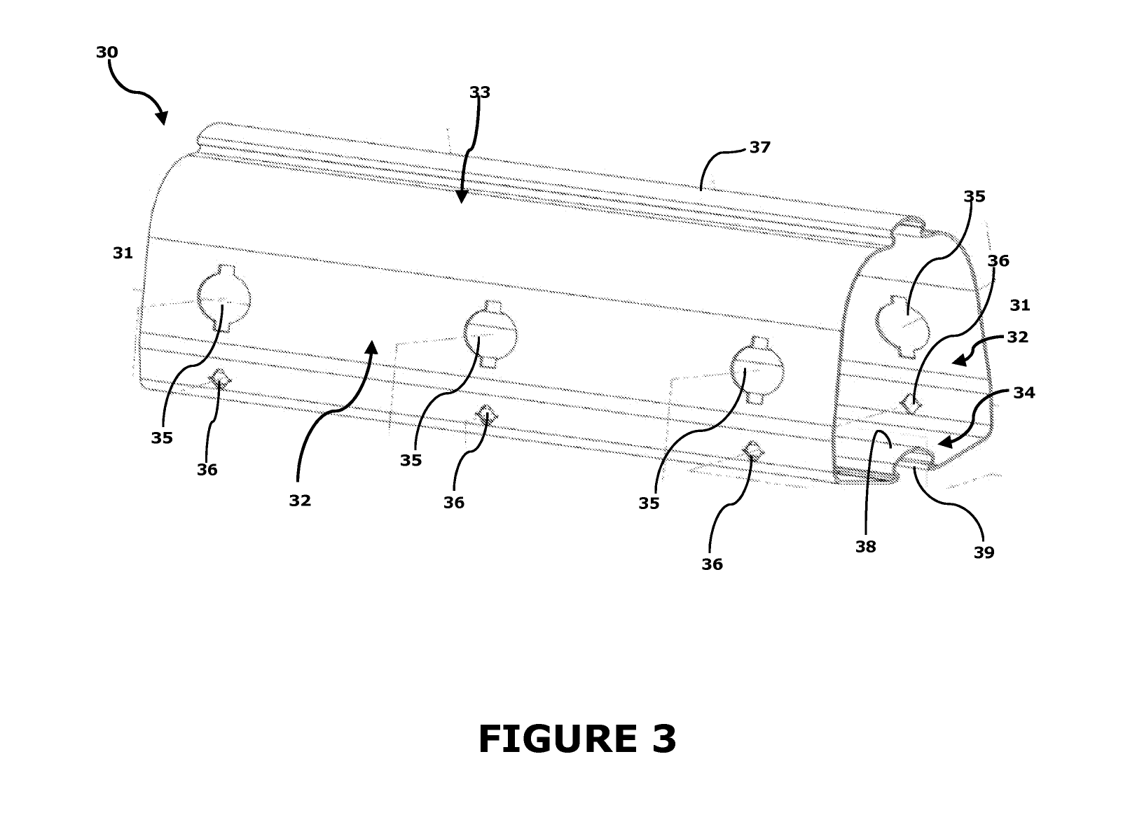

Referring to FIG. 3, the housing tube 30 has front-rear walls 32, a ceiling 33, and a floor 34. The walls 32 forms the compartment's front and rear sides 22, the ceiling 33 forms the compartment's top side 23, and the floor 34 forms the compartment's bottom side 24. The lateral edges of the walls 32, the lateral edges of the ceiling 33, and the lateral edges of the floor 34 define the open ends 31.

Three pairs of port holes 35 and three pairs in the perch-receiving holes 36 are provided in the walls 32, with the holes 35-36 in the front wall 32 aligning with the holes 35-36 in the rear walls. The holes 35 and/or the holes 36 can each have keyed contours.

The housing ceiling 33 includes a curved channel 37 projecting upward therefrom. The housing floor 34 includes a similar channel 38 projecting upward therefrom and forming a bottom recess 39 in the housing tube 30. The illustrated channels 37-38 (and thus also the recess 39) have a curved oblong cross-sectional shape akin to a jigsaw lob.

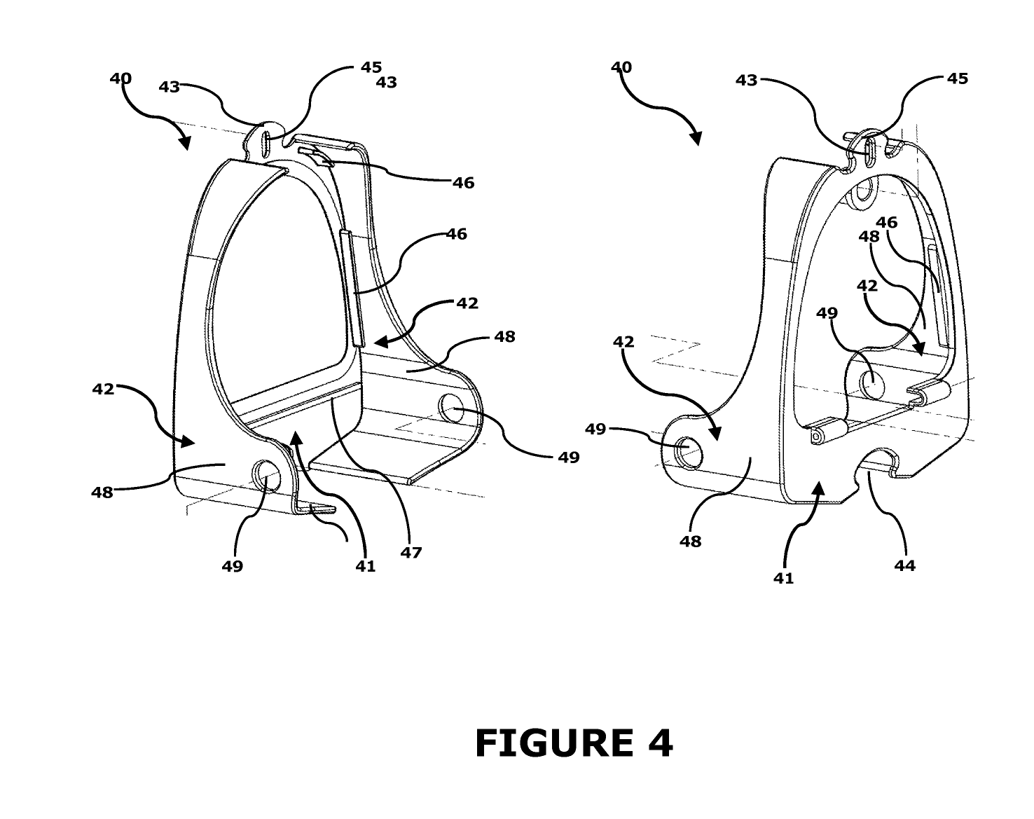

Referring to FIG. 4, the lateral lids 40 each comprise an end wall 41 and a pair of brackets 42. The end walls 41 enclose the open lateral ends 31 of the housing tube 30. The side brackets 42 are adapted to removably attach the end wall 42 to the housing 30 with the help of another component of the birdfeeder 10 (namely a perch 60, introduced below).

Each end wall 41 has a top tab 43 for accommodating the ceiling projection 37 and bottom recess 44 for accommodating the floor projection 38. A hanger-receiving opening 45 can be provided in the top tab 43.

The interior surface of each end wall 41 can be provided with housing-edge-capturing ridges 46. The interior surface of each end wall 41 can additionally or alternatively be provided with a baffle-locking ridge 47.

Each bracket 42 includes an apron 48 provided with an hole 49. The front aprons 48 extend inward from the front and bottom wall edges and the rear aprons 48 extend inward from the rear and bottom wall edges. The holes 49 on end-wall-sharing aprons 48 align with each other and also with the holes 36 in the tube housing 30 adjacent the lateral lids 40.

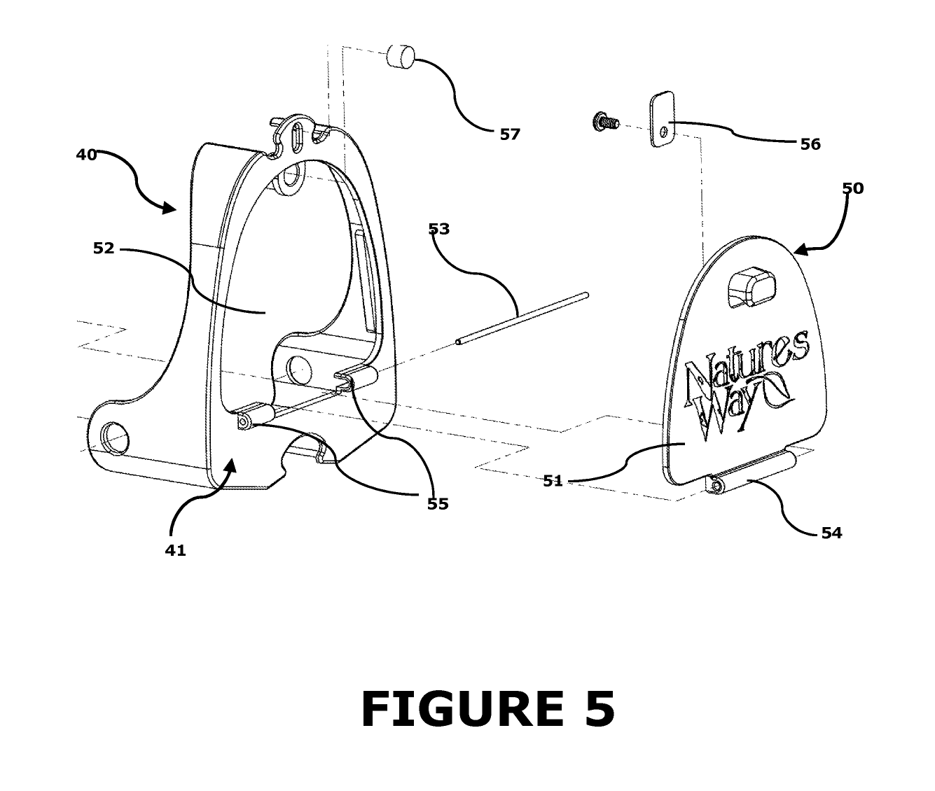

Referring to FIG. 5, at least one of the end lids 40 can have a door 50 allowing selective access to the housing compartment 21. The door 50 can comprise a panel 51 and the lid's end wall 41 can have a window 52 shaped to be opened and closed by the door panel 51. The door panel 51 can be hinged to end wall 41 via a hinge rod 53 held by sleeves 54-55 and/or can be locked in the closed position via magnetic elements 56-57.

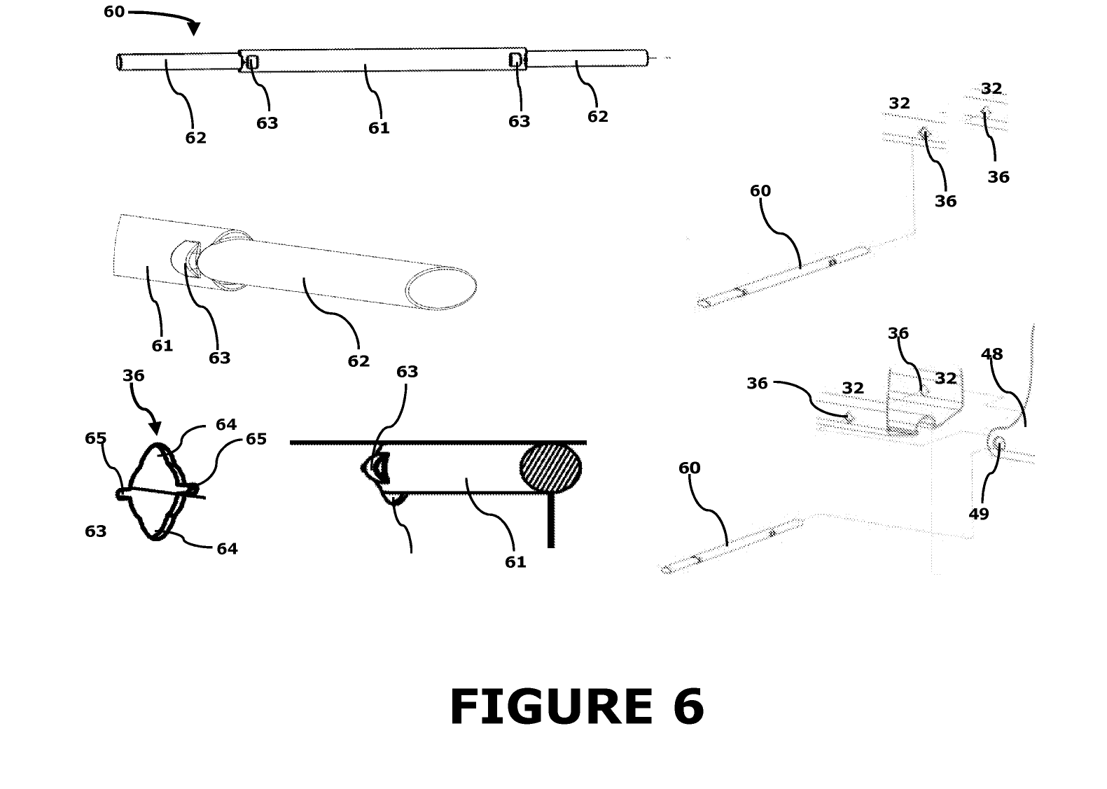

Referring briefly back to FIG. 1 and then to FIG. 6, the birdfeeder 10 additionally comprises perches 60 to provide resting places for birds when accessing feed from the compartment 21. Each perch 60 includes a central portion 61, end portions 62, and locking number 63.

The central portion 61 of each perch 60 has a circular cross-sectional shape and spans the depth of the housing tube 30. The end portions 62 each have oval cross-sectionals shape which elongate in the horizontal dimension. The locking nubs 63 are positioned on each end of the central portion 61 and extend laterally outward therefrom.

To assemble the central perch 60 to the housing tube 30, it is turned sideways to align its oval end portions 62 with the wide oval notches 64 of a perch-receiving hole 36 in the front wall 32. The perch 60 is then inserted through this hole 36 and through the hole 36 on the rear wall 32. The perch 60 is then twisted sideways so that the locking nubs 63 are seated in the narrow oval notches 65 of the perch-receiving holes 36. The perch 60 can be removed in a reverse manner.

As was alluded to above, the perches 60 can be employed in the removable attachment of the lateral end lids 40 to the housing tube 30. In this attachment, the each lid 40 is assembled to the tube 30 so that the tube's lateral edges are received around the lid's ridges 46. The same perch-insertion steps are then followed, with the perch 60 being inserted through both the now aligned tube holes 36 and lid holes 49.

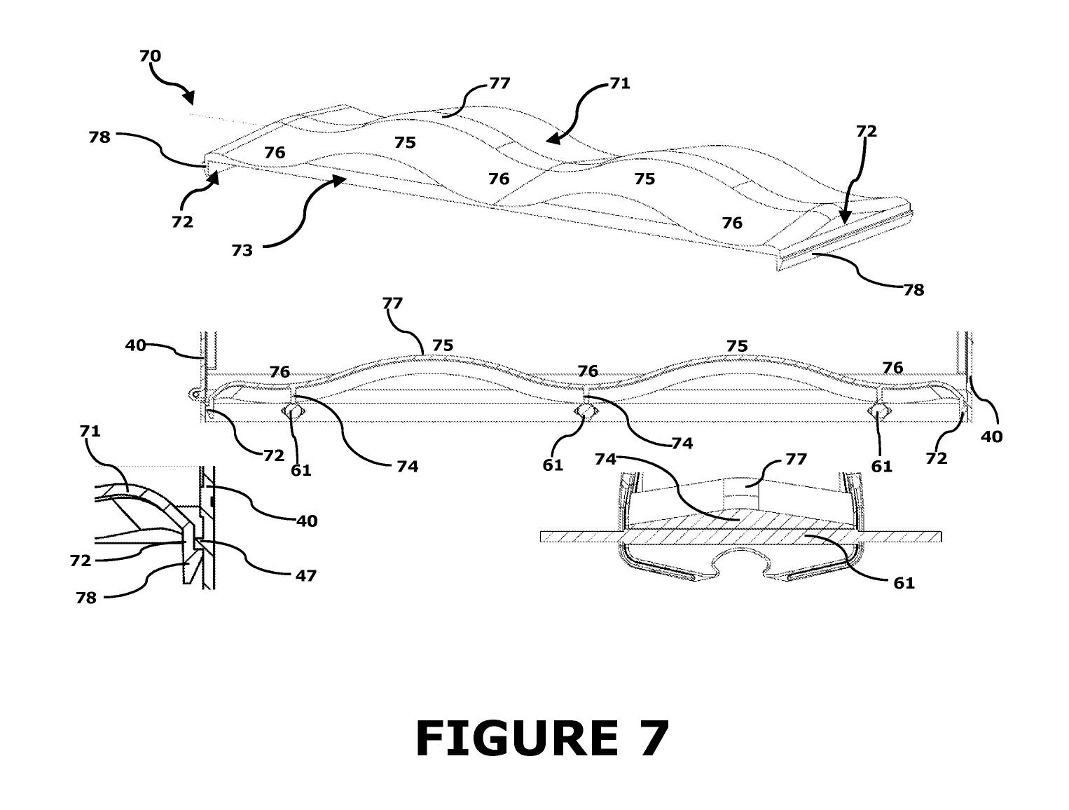

Referring to FIG. 7, the birdfeeder 10 can additionally comprise a baffle 70 removably positioned within the compartment 21 of the housing 20. The baffle 70 is designed to urge birdfeed in the compartment towards the feed ports 34 in the housing tube 30. The illustrated baffle 70 comprises a divert sheet 71, end struts 72, rails 73, and intermediate pedestals 74.

The baffle's diverting sheet 71 laterally extends between the struts 72 and laterally undulates to form hills 75 and valleys 76. The illustrated sheet 71 includes an apex ribbon 77 spanning its width and centrally intersecting each hill 75 and valley 76. The valleys 76 are transversely aligned with the feed ports 74 and slope downward from the apex ribbon 77 in front and rear directions.

The rails 73 are located beneath front and rear edges of the diverting sheet 71 and also extends between the end struts 72. The intermediate pedestals 74 are located below the sheet 71 and above the rails 73, and they transversely span between the sheet's front and rear edges.

In the assembled birdfeeder 10, the rails 73 and/or pedestals 74 rest on the perches 60, and specifically their central portions 61. The end struts 72 are preferably removably attached to the housing lids 40. For example, the end struts 72 can be provided with clasps 78 adapted to snap onto the baffle-locking ridge 47 in the corresponding end lid 40.

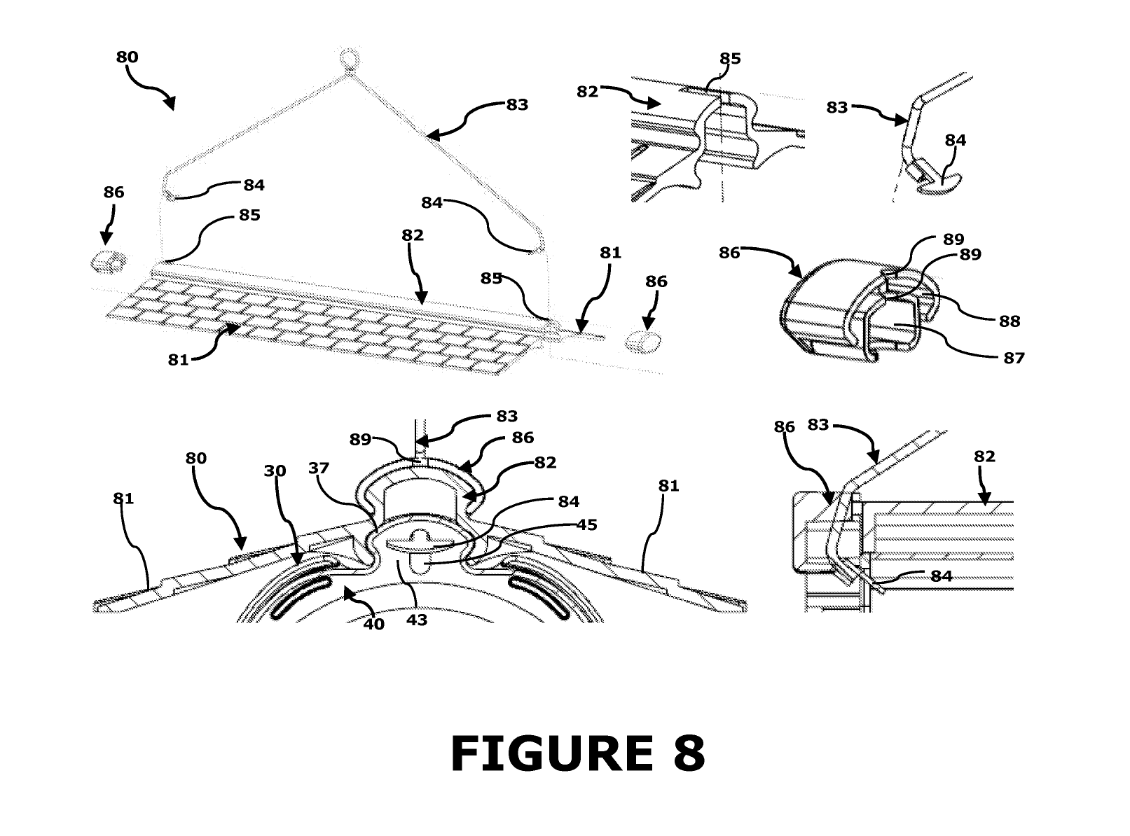

Referring briefly back to FIG. 1, and then to FIG. 8, the birdfeeder 10 can additionally comprise a roof 80 which removably attaches to its housing 20. The roof 80 can comprise awnings 81 which slope downward from a central channel 82. The awnings 81 can be sized and shaped to extend beyond the front-back sides 22 and/or beyond the lateral sides 25 of the housing 20. The channel 82 is sized and shaped for receipt of the ceiling channel 37 in the housing 30.

The roof 80 can further comprise a hanger 83 for suspending the birdfeeder 10 from a branch or other elevated limb. The hanger 83 can be adapted for removable attachment to the channel 82 via end clips 84. In the illustrated embodiment, the hanger end clips 84 have a mushroom shape, and the channels 82 can have slots 85 sized to receive the clip's stems.

To assemble the roof 80 to the housing 20, the ceiling channel 37 is inserted into the roof channel 80. Each of the hanger end clips 84 is then turned so that its mushroom head can be inserted through the opening 45 in the top tab 43 of the end lid 40, and then twisted so as to capture it therein. In the captured orientation, the stem of the hanger end clip 84 fits within the slot 85 in the roof channel 82.

Plugs 86 can be provided to enclose the otherwise open lateral ends of the roof channel 82. Each plug 86 includes an inner pocket 87 for receipt of the corresponding lateral end of the ceiling channel 37, an outer pocket 88 for receipt of the corresponding lateral end of the roof channel 82, and slots 89 for accommodating the corresponding hanger clip 84. The plugs 86 can be placed on the channel ends after assembly of the hanger 83 thereto. If the hanger 83 is not needed, the plugs 86 can be put in place after the housing-channel insertion step.

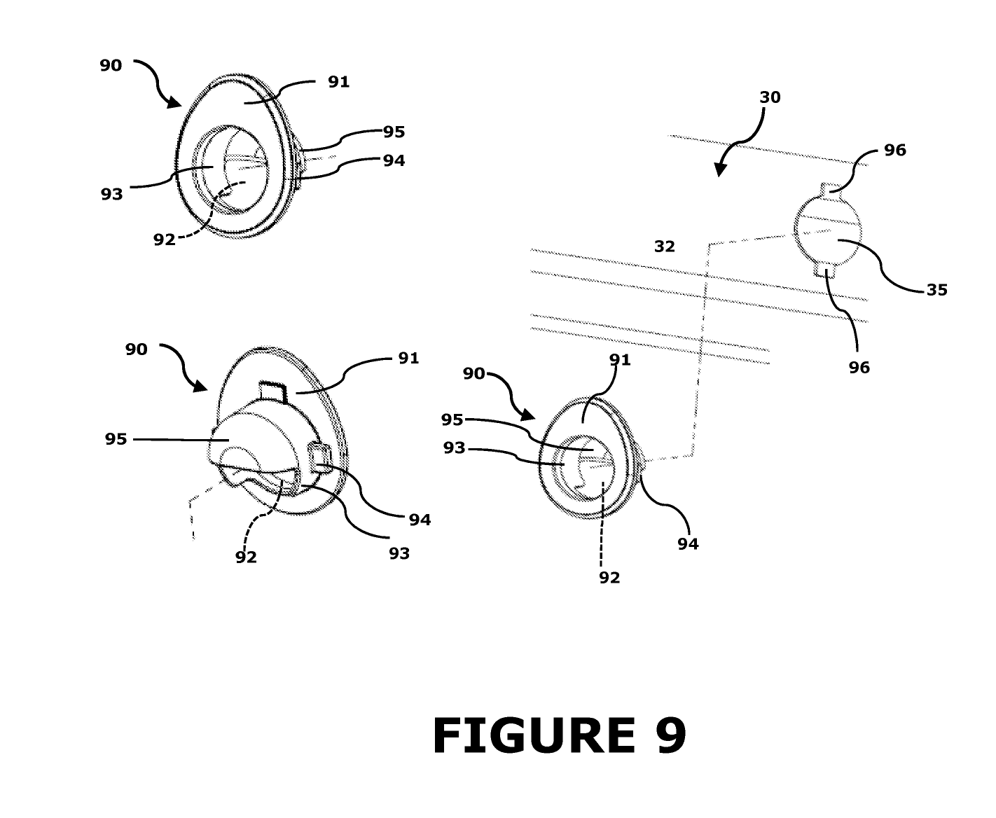

Referring briefly back to FIG. 1 and then to FIG. 9, the birdfeeder 10 can further comprise feed-port inserts 90. Each insert 90 can comprise an ovate-shaped stage 91, having an opening 92. A sleeve 93 extends inward from the opening 92 and surrounds the top and lateral edges of opening 92. Rectangular peninsulas 94 jut outward from opposite lateral regions of the sleeve 93. A brim 95 can extend inward from the upper hemisphere of the sleeve 93.

The feed-port inserts 90 are designed for insertion into the holes 35 in the housing tube 30. With the illustrated insert 90, the housing holes 35 can be provided with top and bottom rectangular notches 96. To assembly a feed-port insert 90 to the housing tube 30, the stage 91 is turned sideways to that its lateral peninsulas 94 are aligned with the top and bottom notches 96 of the hole 35. The sleeve 93, the peninsulas 94, and the brim 95 are then inserted through hole 35, and then the stage 91 is twisted so that the peninsulas 94 are once again located laterally. The port inserts 90 can be removed in a reverse manner from the housing tube 30.

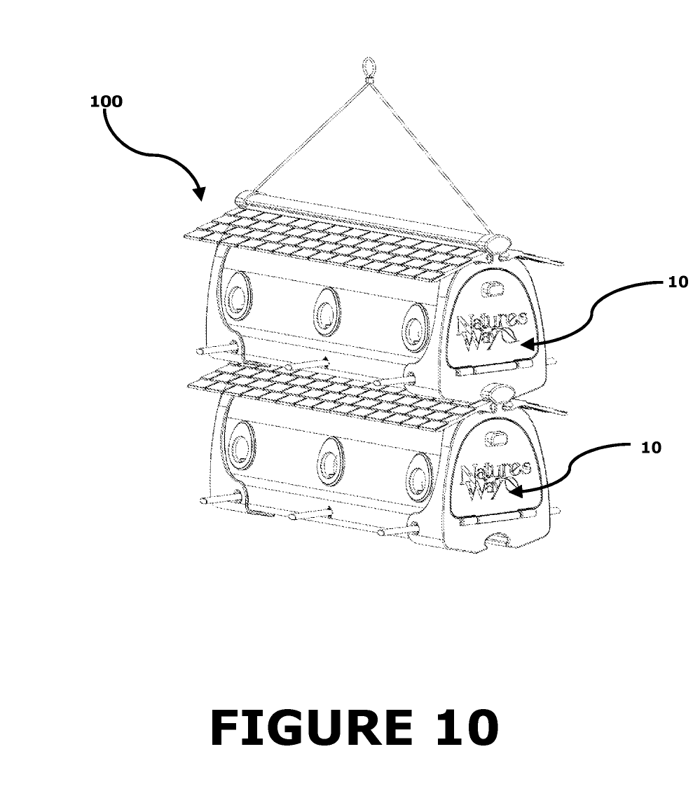

Referring to FIG. 10, a stacked assembly 100 of the birdfeeders 10 is shown. In this assembly 100, a plurality of birdfeeders 10 are connected one on top of the other by inserting the roof channel 82 of the lower birdhouse 10 into the floor recess 39 of the upper birdhouse 10. In the illustrated assembly 100, both of the birdfeeders 10 include roofs 80, but this need not be the case. For example, if the lower birdhouse 10 could be roofless, its ceiling channel 37 could be inserted into the floor recess 39 of the upper birdhouse 10.

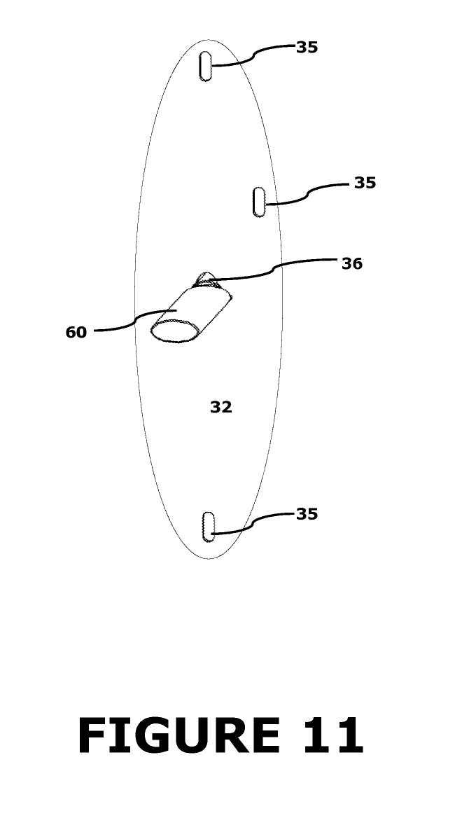

Referring to FIG. 11, a birdfeeder 10 is shown without feed-port inserts 90, whereby the housing holes 34 alone serve as feed ports. This design may be preferable, for example, when very small birdfeed (e.g., thistle) is intended to occupy the compartment 21. The holes 34 can be arranged in the housing 30 near the perch holes 35 whereby they will be near the perches 60 in the birdfeeder 10. The feed-port holes 34 can be situated above and/or below the closest perch hole 35, they can be vertically aligned with the perch hole 35 or with each other, and/or they can be vertically offset with the perch hole 35 and/or each other.

One now may appreciate a birdfeeder 10 is provided with a housing tube 30 having a width substantially larger than its height or depth. Although the birdfeeder 10, the housing 20, the housing tube 30, the end lids 40, the door 50, the perches 60, the baffle 70, the roof 80, the feed ports 90, and/or the assemblies 100 are shown and described as having certain forms and fabrications, such portrayals are not quintessential and represent only some of the possible of adaptations of the claimed characteristics. Other obvious, equivalent, and/or otherwise akin embodiments could instead be created using the same or analogous attributes.

1. A birdfeeder comprising a housing defining a birdfeed-holding compartment having front and rear sides, a top side, a bottom side, and lateral sides;
wherein the compartment has a depth dimension determined by the distance between its front and rear sides, a height dimension determined by its top side and its bottom side, and width dimension determined by its lateral sides, the width dimension exceeding the depth dimension and the height dimension; and
wherein the housing comprises a plastic housing tube which defines at least the front and rear sides, the top side, and the bottom side of the compartment.

2. A birdfeeder as set forth in claim 1, wherein the housing comprises end lids removably attachable to open lateral ends of the housing tube.

3. A birdfeeder as set forth in claim 2, further comprising a door on at least one of the end lids for selective access to the birdfeed-holding compartment.

4. A birdfeeder as set forth in claim 2, further comprising a perch for each end lid which secures the lid to the housing tube.

5. A birdfeeder as set forth in claim 1, further comprising at least one perch extending beyond the birdfeed-holding compartment.

6. A birdfeeder as set forth in claim 1, further comprising a plurality of perches extending beyond the birdfeed-holding compartment.

7. A birdfeeder as set forth in claim 1, further comprising a baffle comprising a diverting sheet shaped to urge birdfeed in the compartment towards feed ports.

8. A birdfeeder as set forth in claim 1, further comprising a roof removably attached to the housing tube.

9. A birdfeeder as set forth in claim 8, wherein the tube housing has a ceiling with a central channel projecting upward therefrom; wherein the roof comprises awnings which slope downward from a central channel; and wherein the ceiling's central channel is insertable into the roof's central channel to removably attach the roof to the housing.

10. A birdfeeder as set forth in claim 9, wherein the roof also comprises a hanger removably attached to its central channel.

11. A birdfeeder as set forth in claim 9, wherein the roof comprises plugs for closing the ends of the roof's central channel.

12. A birdfeeder as set forth in claim 9, wherein the tube housing has a floor with a channel projecting upward therefrom and forming a bottom recess in the housing tube, and wherein the roof's central channel is shaped to be insertable into bottom recess of the housing tube.

13. A stacked assembly comprising a plurality of birdfeeders as set forth in claim 12, wherein the roof's central channel of the lower birdfeeder is inserted into the bottom recess of the upper birdfeeder.

14. A birdfeeder as set forth in claim 1, further comprising one or more feed ports removably attached to the housing.

15. A birdfeeder as set forth in claim 14, wherein:
the housing tube has a hole with a keyed contour for each feed port;
each feed port comprises a stage, an opening in the stage, and sleeve extending inward from the opening, the sleeve having a key contour complimentary to that of the housing hole; and
when the stage is turned, the sleeve can be inserted into the housing hole and when the stage is turned back after insertion of the sleeve, the feed port is securely attached to the housing tube.

16. A birdfeeder as set forth in claim 1, wherein the housing tube has a ceiling forming the compartment's top side and a floor forming the compartment's bottom side; and wherein:
the ceiling has a channel projecting upward therefrom;
the floor has a similar channel projecting upward therefrom and forming a bottom recess in the housing tube; and
the ceiling channel is shaped to be insertable into the bottom recess.

17. A stacked assembly comprising a plurality of birdfeeders as set forth in claim 16, wherein the ceiling channel of the lower birdfeeder is inserted into the bottom recess of the upper birdfeeder.

18. A birdfeeder as set forth in claim 1, including at least one perch extending beyond the birdfeed-holding compartment; and wherein the housing tube includes at least one hole situated near the perch to serve as a feed port, this hole being vertically offset from the perch.

19. A birdfeeder as set forth in claim 1, including at least one perch extending beyond the birdfeed-holding compartment; and wherein the housing tube includes at least two holes situated near the perch to serve as feed ports, these two holes being vertically offset from each other.

20. A birdfeeder as set forth in claim 1, including at least one perch extending beyond the birdfeed-holding compartment; and wherein the housing tube includes at least two holes situated near the perch to serve as feed ports, one of these holes being located above the perch and the other hole being located below the perch.
